(19) United States
(12) Patent Application Publication
(10) Pub. No.: US 2018/0106219 A1
(43) Pub. Date: Apr. 19, 2018

(54) PROPULSION SYSTEM

(71) Applicant: Lonnie Joseph Parker, Texarkana, AR (US)

(72) Inventor: Lonnie Joseph Parker, Texarkana, AR (US)

(21) Appl. No.: 15/730,991

(22) Filed: Oct. 12, 2017

Related U.S. Application Data
(60) Provisional application No. 62/407,677, filed on Oct. 13, 2016.

(51) Int. Cl. F02K 9/42

(52) U.S. Cl. CPC F02K 9/42; F02K 9/60

(57) ABSTRACT

A propulsion system is provided. The propulsion system provides a single or array of low power pulsed lasers used to accelerate water vapor or other molecules to relativistic velocities using the Wakefield effect. The present invention provides a thrust plate having one or more thrust channels operatively associated with the single or array of low power pulsed lasers, wherein the resulting electric field of the Wakefield effect accelerates the water or molecular ions at high speeds out of the thrust plate through the thrust channels.

### CROSS-REFERENCE TO RELATED APPLICATION

This application claims the benefit of priority of U.S. provisional application No. 62/407,677, filed 13 Oct. 2016, the contents of which are herein incorporated by reference.

### BACKGROUND OF THE INVENTION

The present invention relates to propulsion systems and, more particularly, a propulsion system having a single or array of low power pulsed lasers used to accelerate water, water vapor or other gas to relativistic velocities using the Wakefield effect.

The thrust of a rocket engine is determined by mass fuel flow and ejection velocity of the fuel. The limits of current rocket engines are defined by the temperature and pressure of combustion and mass fuel flow. Modern rocket engines are about 98% efficient and have reached their practical limits, wherein current rockets can only have about 5% of their mass as payload.

Nuclear rocket engines theoretically offer greater performance than traditional rockets, but current nuclear rocket engine designs also depend on heat and pressure to accelerate the fuel. This fuel is in direct contact with parts of the engine producing several practical limitations. First, no known chamber material can withstand even a fraction of the temperature and pressure needed to produce relativistic fuel ejection velocities. Second, the tremendous stress placed on the combustion chamber and nozzle of conventional chemical and nuclear engines limit their useful lifetime to at most a few hours.

Ion and magnetohydrodynamic engines use electric or magnetic fields to accelerate an ionized fuel. These, however, have a highest speed so far of around 49,000 m/s with very low propellant flow, thereby generating a very low thrust. The power requirements and inefficient acceleration of propellant in the ion and magnetohydrodynamic engines limit their thrust so much that they cannot be used to launch anything into space and are only useful once already in orbit. They also require very rare gases such as Xenon and Krypton.

These limitations prevent the superior mass to payload ratio and resultant acceleration and velocity performance of the Wakefield design.

As can be seen, there is a need for a propulsion system having a single or array of low power pulsed lasers used to accelerate water vapor or other gas to relativistic velocities using the Wakefield effect. The effects of accelerating rocket engine fuel to relativistic velocities can increase the effective mass of the fuel to as much as 48× its rest mass thereby overcoming the fuel mass limits of current technology. Laser-driven Wakefield engines can accelerate fuel to velocities 6000 times greater than the most efficient competing engines. In other words, no other rocket engine, chemical, nuclear, ion or magnetohydrodynamic has produced an ejection velocity greater than 0.0164% the ejection velocity of the engine of the present invention.

### SUMMARY OF THE INVENTION

In one aspect of the present invention, a propulsion system including a thrust plate providing one or more thrust channels; a single or array of lasers, one of the single or array of lasers operatively associated with each thrust channel; and ionizable molecules fluidly communicated to each thrust channel, wherein each laser is configured at a predetermined rate sufficient to produce a Wakefield effect necessary to accelerate the respective communicated ionizable molecules to relativistic velocities.

In another aspect of the present invention, the propulsion system includes a thrust plate providing one or more thrust channels; a water cooling channel operatively associated with each thrust channel; a single or array of low power pulsed lasers, one of the single or array of lasers operatively associated with each thrust channel via at least one fiber optic cable; and water vapor fluidly communicated to each thrust channel, wherein each laser is configured to produce an electromagnetic wave having a wavelength highly absorbed by the water vapor and at a predetermined rate sufficient to produce a Wakefield effect necessary to accelerate the respective communicated ionizable molecules to relativistic velocities, and wherein the ionizable molecules are accelerated parallel to opposing channel walls of each thrust channel, whereby heat transfer to said channel walls is limited.

These and other features, aspects and advantages of the present invention will become better understood with reference to the following drawings, description and claims.

### BRIEF DESCRIPTION OF THE DRAWINGS

FIG. 1 is a schematic view of an exemplary embodiment of the present invention;

FIG. 2 is a schematic view of an exemplary embodiment of the present invention; and

FIG. 3 is a schematic view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a propulsion system having a single or array of low power pulsed lasers used to accelerate water vapor or other ionizable molecules to relativistic velocities using the Wakefield effect. The present invention provides a thrust plate having one or more thrust channels operatively associated with the single or array of low power pulsed lasers, wherein the resulting electric field of the Wakefield effect accelerates the water or molecular ions at high speeds out of the thrust plate through the thrust channels. Whereby the resultant fuel ejection velocity and concomitant thrust are superior as compared to current propulsion systems.

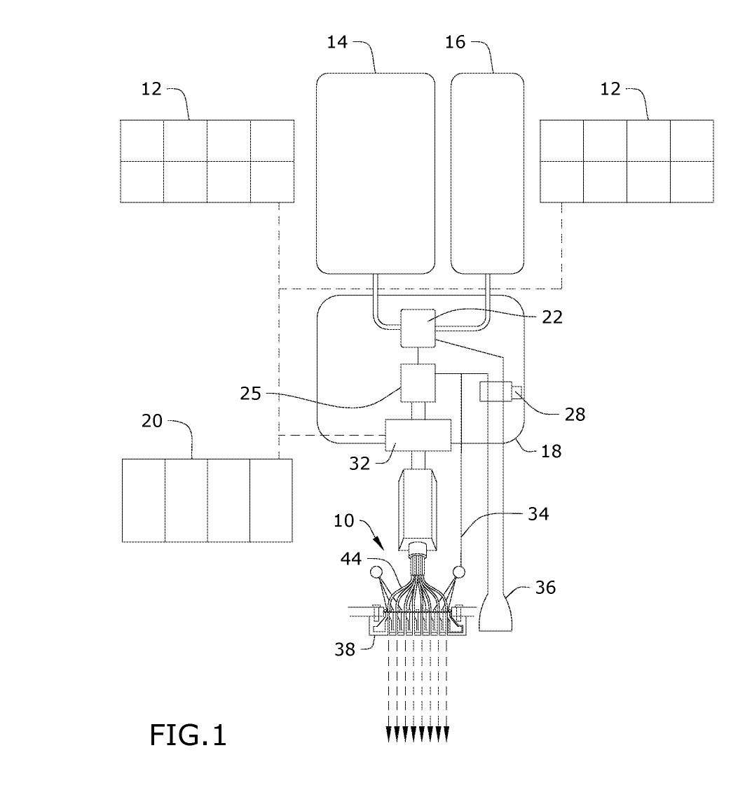

Referring to FIG. 1, the present invention burns oxygen (retrievably housed in a liquid oxygen storage tank 16) and hydrogen (retrievably housed in a liquid hydrogen storage tank 14) in a combustion chamber 22, forming water. The water may be in the form of steam and directed to a turbine 54 to generate electricity with the aid of a generator 25. The electricity may be regulated by a current controller 32 so that the electricity can be used to power lasers 46, such as erbium YAG lasers, wherein the lasers 46 may be directed by fiber-optic cable 44 into an array of thrust channels 60 in a thrust plate 38.

Said water may provide water vapor which may be directed from a water source (e.g., a reserve tank 18) via first feed lines 34 and then directed to the thrust channels 60 in the thrust plate 38, in certain embodiments, by way of fluidly connected second feed lines 42. In some embodiments, water cooling channels 40 are operatively associated with the thrust channels 60, and the water cooling channels 40 are fluidly connected to the second feed lines 42. The laser beam may be directed through a fiber optic cable 44 to an array of thrust channels 60 in the thrust plate 38; pulsed through the thrust channels 60 at a rate that produces a Wakefield effect necessary to accelerate the water vapor to relativistic velocities, wherein the electrons are stripped off the water vapor and propelled at relativistic velocities out of the thrust plate 38. This creates an electric field that accelerates the water ions at high speeds out of the thrust plate 38. This Wakefield effect has been used in table-top particle accelerators to achieve velocities over 99% the speed of light. A fraction of this increase in fuel ejection velocity would allow for orders of magnitude greater thrust and fuel efficiency than any other engine now available.

The laser 46 may be configured to produce an electromagnetic wave having a wavelength and/or oscillation frequency that is very highly absorbed by water. This will allow the laser 46 to strip electrons off of the water vapor molecules. The laser 46 may be pulsed so as to create the Wakefield effect and propel the electrons to near light speed, creating a powerful electric force which will accelerate the resultant water vapor ions through the thrust channel 60 at very high speeds. This pulse of high speed molecules will drag the other water vapor molecules with them in the established Wakefield effect manner. These molecules are accelerated parallel to the thrust channel walls and are self-lensing thereby limiting heat transfer to the channel walls.

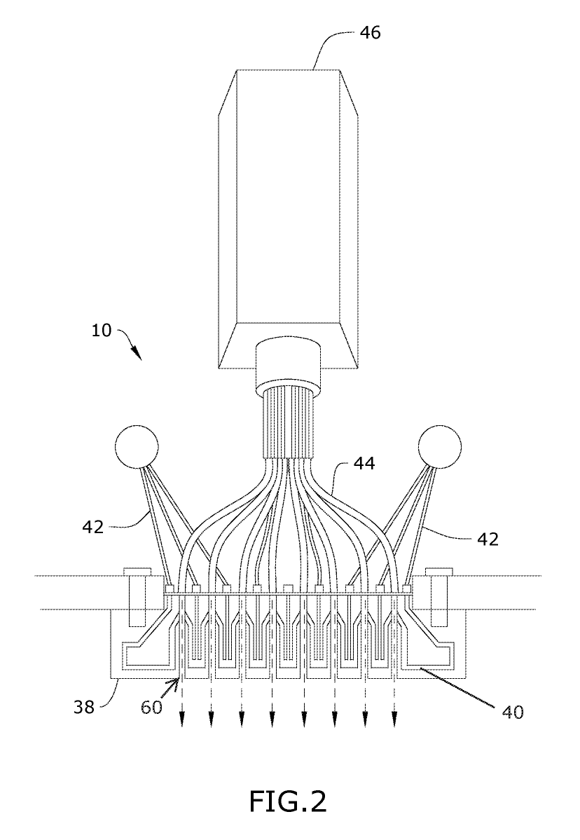

Referring to FIG. 2, the thrust plate 38 is unique to this design and will need to be 3D printed with cooling channels, water lines and thrust channels 60 in place. A strong metal alloy or ceramic can be used for this purpose. The erbium laser may use flexible fiber optic cables 44 to distribute the pulse over hundreds or thousands of thrust channels 60 in the thrust plate 38.

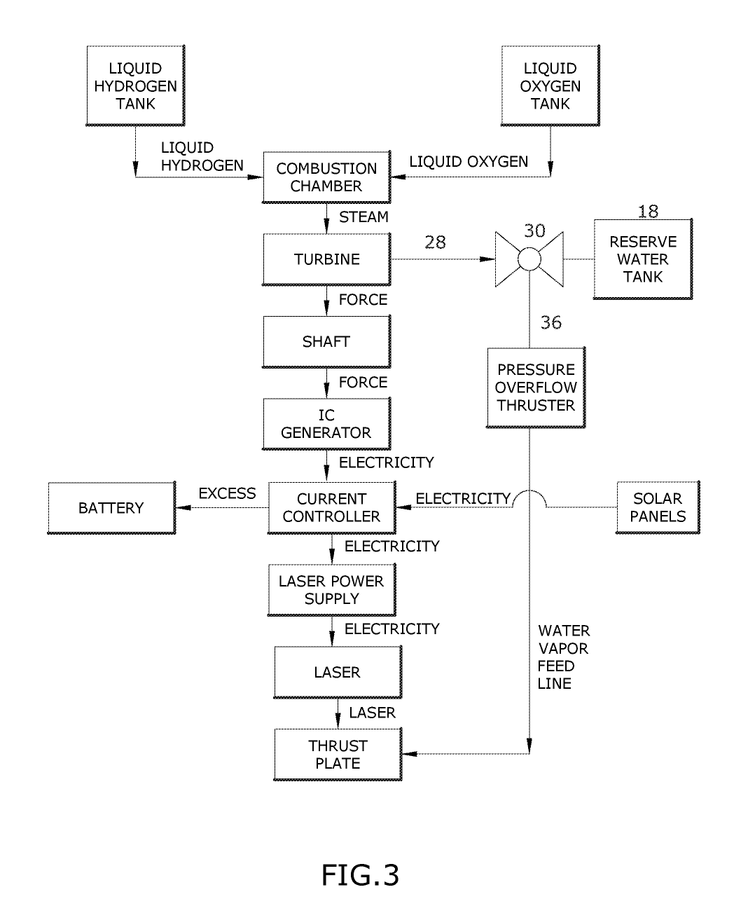

Referring to FIG. 3, the hydrogen and oxygen may be combined in the combustion chamber 22 and ignited. The exhaust goes through the turbine 54 to turn the generator 25. Excess pressure from the combustion chamber 22 can be relieved through conventional thrust ports/vents. In certain embodiments, the reserve tank 18 may be used to collect and store excess water via a water feed 28 operatively associated with a valve 30 fluidly coupled to an over pressure vent 36. The generator 25 produces electricity that may be regulated by the current controller 32 and sent to the laser power supply 20, wherein excess electricity may be sent to charge batteries. The solar panels 12 can be used to hydrolyze the water back into oxygen and hydrogen fuel. The laser power supply 20 shown in the Figures may be used to power the laser driver 10. The hydrogen and oxygen fuel are combusted at a low rate to generate the electricity and water vapor fuel needed to produce the Wakefield effect. Excess water may be collected for hydrolysis back to hydrogen and oxygen gas, for radiation shielding, for crew use, and as a source of water vapor if the laser 46 has to be powered by backup batteries, or solar power if the turbine 54 or generator 25 needs repair.

The present invention could be used with only batteries, only solar panels 12, or other power source as their power supply 20 and a water vapor supply. It would be most efficient to burn the hydrogen and oxygen fuel to generate both the power for the lasers 46 and the water vapor fuel to be ejected.

Other fuels such as hydrogen gas from liquid hydrogen could be used with other types of lasers with the same thrust plate configuration and produce effective thrust though not as efficiently as the proposed design.

Also, through the present invention, the method of using pulsed lasers to create a Wakefield effect through an array of channels could be used to generate thrust in various rocket engine applications, or could be used to accelerate protons to collide with boron-11 or lithium-7 targets and produce aneutronic fusion for power or other purposes. It could also accelerate helium-3 ions to collide with each other to produce aneutronic fusion in a similar manner.

It should be understood, of course, that the foregoing relates to exemplary embodiments of the invention and that modifications may be made without departing from the spirit and scope of the invention as set forth in the following claims.

What is claimed is:

1. A propulsion system, comprising:
a thrust plate providing one or more thrust channels;
a single or array of lasers, one of the single or array of lasers operatively associated with each thrust channel; and
ionizable molecules fluidly communicated to each thrust channel,
wherein each laser is configured at a predetermined rate sufficient to produce a Wakefield effect necessary to accelerate the respective communicated ionizable molecules to relativistic velocities.

2. The propulsion system of claim 1, wherein each laser is a pulsed laser.

3. The propulsion system of claim 1, wherein each laser is a low power pulsed laser.

4. The propulsion system of claim 1, wherein each laser is operatively associated with each thrust channel via at least one fiber optic cable.

5. The propulsion system of claim 1, wherein the ionizable molecules is water vapor.

6. The propulsion system of claim 1, further comprising a water cooling channel operatively associated with each thrust channel.

7. The propulsion system of claim 1, wherein each laser is configured to produce an electromagnetic wave having a wavelength highly absorbed by the ionizable molecules.

8. The propulsion system of claim 1, wherein the ionizable molecules are accelerated parallel to opposing channel walls of each thrust channel, whereby heat transfer to said channel walls is limited.

9. A propulsion system, comprising:
a thrust plate providing one or more thrust channels;
a water cooling channel operatively associated with each thrust channel;
a single or array of low power pulsed lasers, one of the single or array of lasers operatively associated with each thrust channel via at least one fiber optic cable; and
water vapor fluidly communicated to each thrust channel,
wherein each laser is configured to produce an electromagnetic wave having a wavelength highly absorbed by the water vapor and at a predetermined rate sufficient to produce a Wakefield effect necessary to accelerate the respective communicated ionizable molecules to relativistic velocities, and wherein the ionizable molecules are accelerated parallel to opposing channel walls of each thrust channel,
whereby heat transfer to said channel walls is limited.
